(19) United States
(12) Patent Application Publication
(10) Pub. No.: US 2013/0158962 A1
(43) Pub. Date: Jun. 20, 2013

(54) Systems and Methods for Computing a Default 3D Variogram Model

(71) Applicants: Jeffrey Yarus, Houston, TX (US); Genbao Shi, Sugar Land, TX (US); Richard L. Chambers, Bixby, OK (US)

(72) Inventors: Jeffrey Yarus, Houston, TX (US); Genbao Shi, Sugar Land, TX (US); Richard L. Chambers, Bixby, OK (US)

(73) Assignee: Landmark Graphics Corporation, Houston, TX (US)

(21) Appl. No.: 13/805,241

(22) PCT Filed: Jun. 18, 2010
(86) PCT No.: PCT/US10/39163

§ 371 Date: Feb. 28, 2013

(51) Int. Cl. G06F 17/50

(52) U.S. Cl. CPC G06F 17/5009
USPC 703/2

(57) ABSTRACT

Systems and methods for computing a variogram model, which utilize a vertical experimental variogram and a horizontal experimental variogram to calculate a 3D default variogram model.

### CROSS-REFERENCE TO RELATED APPLICATIONS

This application and U.S. patent applications Ser. No. 12/605,945 and 12/229,879, which are incorporated herein by reference, are commonly assigned to Landmark Graphics Corporation.

### STATEMENT REGARDING FEDERALLY SPONSORED RESEARCH

Not applicable.

### FIELD OF THE INVENTION

The present invention generally relates to computing a variogram model for geostatistics/property modeling. More particularly, the present invention relates to an automated process for computing a default three-dimensional (“3D”) variogram model using a vertical experimental variogram and a horizontal experimental variogram.

### BACKGROUND OF THE INVENTION

Finding a variogram model is one of most important and often difficult tasks in geostatistics/property modeling as it identifies the maximum and minimum directions of continuity of a given geologic or petrophysical property or any spatially correlated property. The “maximum direction of continuity” is the azimuth along which the variance of a given property changes the least. The “minimum direction of continuity” is a direction perpendicular to the maximum direction of continuity, which is the azimuth along which the variance of a given property changes the most.

Conventional methods for the computation and fitting of a traditional semi-variogram often require domain expertise on the part of the user and considerable trial and error. Conventional methods for automated semi-variogram fitting also focus on least squares methods of fitting a curve to a set of points representing an experimental semi-variogram.

Many commercial software packages offer traditional trial and error fitting. In FIG. 1, for example, traditional trial and error semi-variogram modeling is illustrated using ten (10) experimental semi-variograms in a graphical user interface 100. Each experimental semi-variogram is computed along a different azimuth. The number of experimental semi-variograms is dependent on the number of input data points and the number of data pairs in the computation. Ten were chosen for this example and produced satisfactory results based on 261 input data points. The user must experiment with the number of direction, with a minimum of 2 and a maximum of 36; the latter of which is computed every 5 degrees.

In each semi-variogram illustrated in FIG. 1, the user drags a vertical line 102 (left or right) using a pointing device until a line 104 is a “best fit” between the points in each semi-variogram. The user also has a choice of model types such as, for example, spherical, exponential, and Gaussian, when fitting the experimental semi-variogram points. This type of non-linear fitting is available in commercial software packages, such as a public domain product known as “Uncert,” which is a freeware product developed by Bill Wingle, Dr. Eileen Poeter, and Dr. Sean McKenna.

In automated fitting, the concept would also be to fit a curve to the semi-variogram points, but the software would use some approximation of the function to produce the best fit. As illustrated in FIG. 2, for example, traditional automated-linear semi-variogram fittings are compared to each experimental semi-variogram for FIG. 1 in the display 200. The linear best-fit shown in FIG. 2, however, is not very good for most rigorous cases. In most automated cases, the approach requires some form of curve (non-linear) fitting method that is “blind” to the user. An approach is blind to the user when the user cannot give any input to the fit achieved by the automated function.

There is therefore, a need for a variogram model that serves as an efficient default model when there is sparse well data and is not blind to the user.

### SUMMARY OF THE INVENTION

The present invention meets the above needs and overcomes one or more deficiencies in the prior art by providing systems and methods for computing a variogram model, which utilize a vertical experimental variogram and a horizontal experimental variogram to calculate a default variogram model.

In one embodiment, the present invention includes a computer-implemented method for computing a variogram model, which comprises: i) selecting input data and grid data, the input data comprising at least well log data and secondary data; ii) processing the input data using a computer to apply a normal score transform to the input data or to standardize the input data; iii) calculating a vertical experimental variogram using a) the well log data after it is processed using the computer; b) a default vertical unit lag distance; and c) a default number of lags for the vertical experimental variogram; iv) calculating horizontal experimental variograms using i) the secondary data after it is processed using the computer; v) a default horizontal unit lag distance; and iii) a default number of lags for the horizontal experimental variogram; and vi) auto-fitting the vertical experimental variogram and the horizontal experimental variogram to form the variogram model, which represents a default 3D variogram model.

In another embodiment, the present invention includes a program carrier device having computer executable instructions for computing a variogram model. The instructions are executable to implement: i) selecting input data and grid data, the input data comprising at least well log data and secondary data; ii) processing the input data using a computer to apply a normal score transform to the input data or to standardize the input data; iii) calculating a vertical experimental variogram using a) the well log data after it is processed using the computer; b) a default vertical unit lag distance; and c) a default number of lags for the vertical experimental variogram; iv) calculating horizontal experimental variograms using i) the secondary data after it is processed using the computer; v) a default horizontal unit lag distance; and iii) a default number of lags for the horizontal experimental variogram; and vi) auto-fitting the vertical experimental variogram and the horizontal experimental variogram to form the variogram model, which represents a default 3D variogram model.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings in which like elements are referenced with like reference numerals, and in which:

FIG. 1 illustrates traditional trial and error semi-variogram modeling using ten (10) experimental semi-variograms.

FIG. 2 illustrates traditional automated-linear semi-variogram fittings for each experimental semi-variogram in FIG. 1.

FIG. 3 is a flow diagram illustrating one embodiment of a method for implementing the present invention.

FIG. 4 illustrates a graphical user interface for selecting input data, grid data and variogram use.

FIG. 5 illustrates a graphical user interface for displaying the parameters for a vertical experimental variogram.

FIG. 6 illustrates a graphical user interface for displaying the parameters for a horizontal experimental variogram.

FIG. 7 illustrates a graphical user interface for displaying a variogram map and a rose diagram.

FIG. 8A is a graphical representation illustrating the vertical experimental variogram calculated in the vertical direction according to step 312 in FIG. 3.

FIG. 8B is a graphical representation illustrating the horizontal experimental variogram calculated in the major direction according to step 312 in FIG. 3.

FIG. 8C is a graphical representation illustrating the horizontal experimental variogram calculated in a direction perpendicular to the major direction according to step 312 in FIG. 3.

FIG. 9A is a graphical representation illustrating the vertical experimental variogram and the autofitted variogram model calculated along the vertical direction in FIG. 8A according to step 314 in FIG. 3.

FIG. 9B is a graphical representation illustrating the horizontal experimental variogram and the autofitted variogram model calculated along the major direction in FIG. 8B according to step 314 in FIG. 3.

FIG. 9C is a graphical representation illustrating the horizontal experimental variogram and the autofitted variogram model calculated along the direction perpendicular to the major direction in FIG. 8C according to step 314 in FIG. 3.

FIG. 10 is a block diagram illustrating one embodiment of a computer system for implementing the present invention.

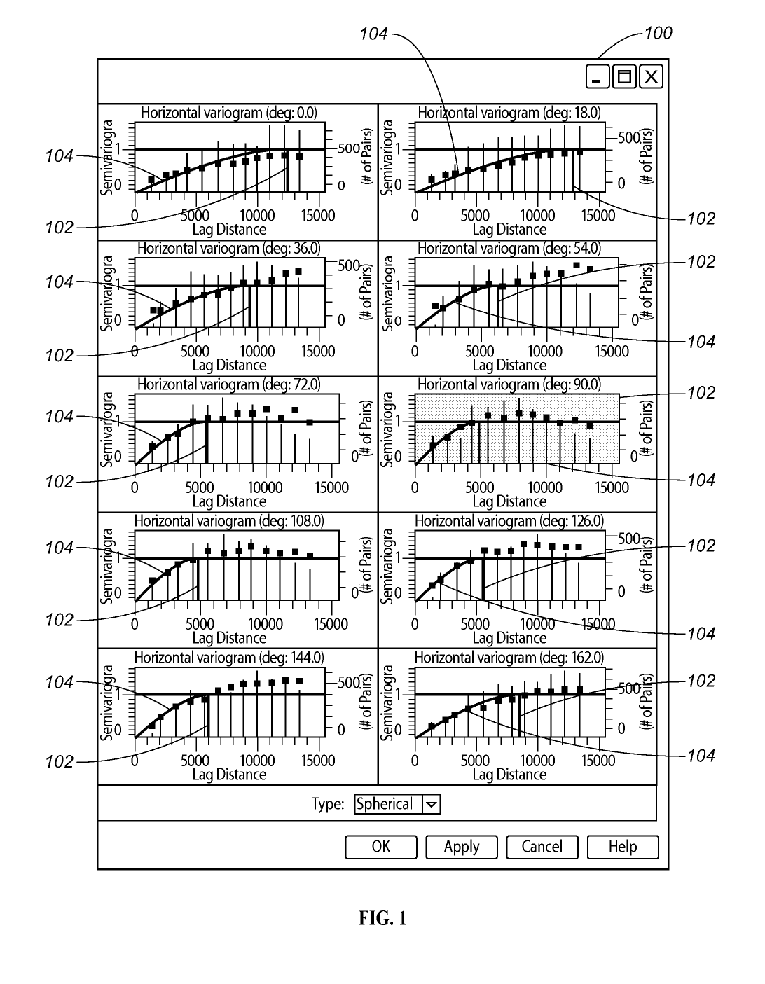

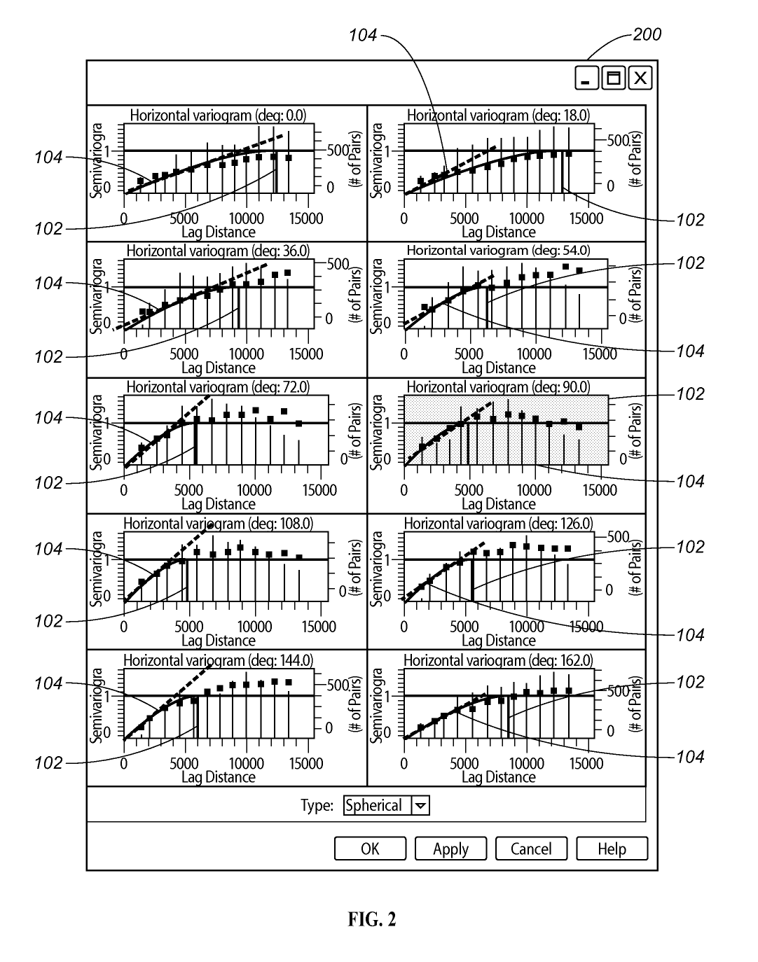

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied to other industries to achieve similar results.

### Method Description

The present invention provides a more efficient process to determine an intelligent-default for a 3D variogram model by computing a vertical experimental variogram using well log data and a horizontal experimental variogram using seismic data. The process then applies auto-fitting to find the default 3D variogram model using the vertical experimental variogram and the horizontal experimental variogram. The process assumes there is adequate vertical information from well log data but inadequate horizontal information from well log data to determine the appropriate parameterization. The process also assumes there is adequate secondary information from seismic data to offset the lack of horizontal well log data. Further, the process assumes there is a relationship between the seismic data and the well log properties being modeled and that the seismic data includes a property that has a similar spatial variability as the well log property.

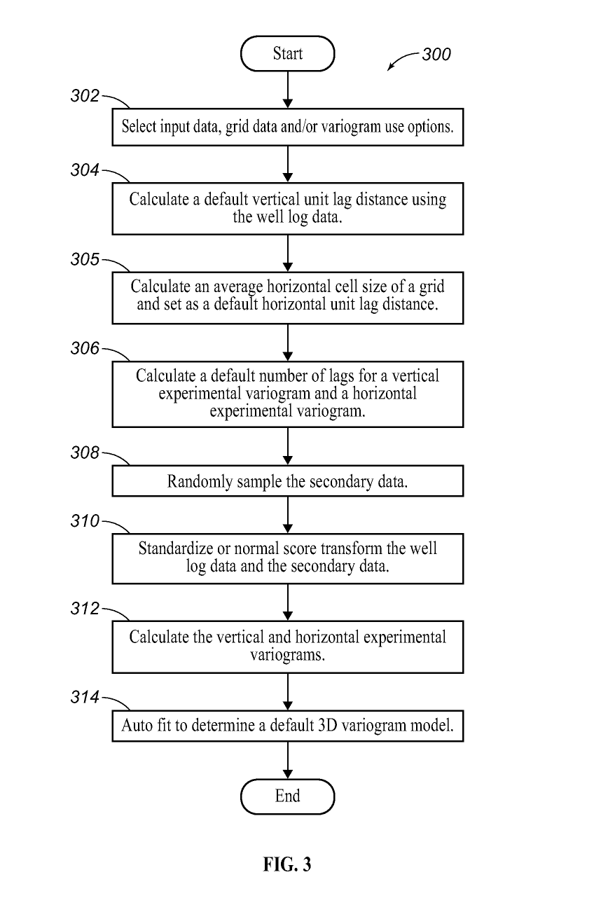

Referring now to FIG. 3, a flow diagram illustrates one embodiment of a method 300 for implementing the present invention.

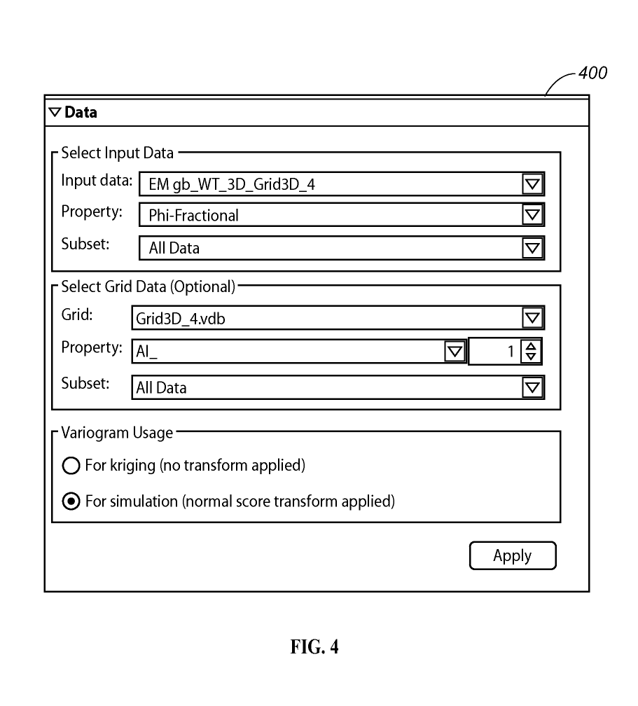

In step 302, input data, grid data and/or variogram use options are selected using a graphical user interface. As illustrated by the graphical user interface 400 in FIG. 4, input data, grid data and/or variogram use options may be selected. The input data may include well log data and secondary data such as, for example, seismic data. Grid data may include, for example, gridded porosity data and gridded seismic data. The variogram use options may include, for example, kriging and simulation.

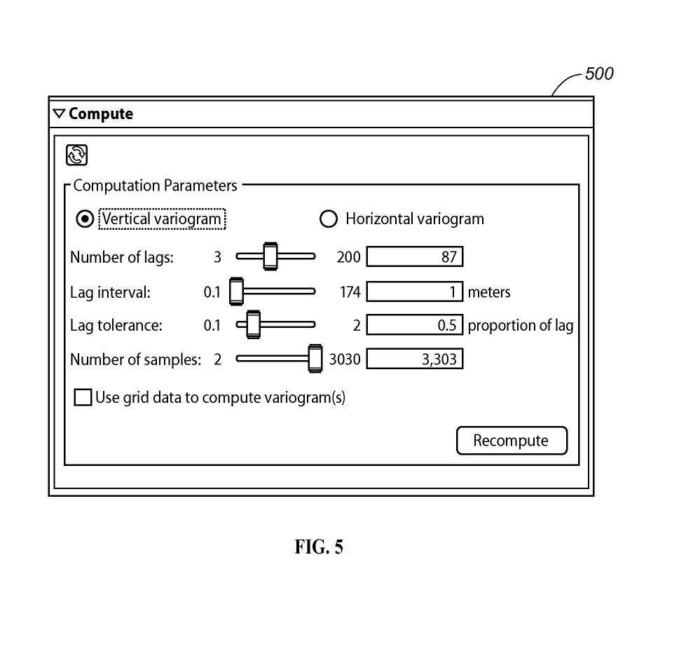

In step 304, a default vertical unit lag distance is calculated for a vertical experimental variogram using the well log data selected in step 302. The computation is performed along each well and determines the distance between two adjacent samples, which are collected to form a distribution. Outliers are eliminated and the mean of the distribution is calculated and used as the default vertical unit lag distance. In this manner, the computation can handle not only vertical wells, but also deviated wells. As illustrated by the graphical user interface 500 in FIG. 5, the computed result for the vertical experimental variogram may be displayed as a lag interval and manually adjusted if necessary.

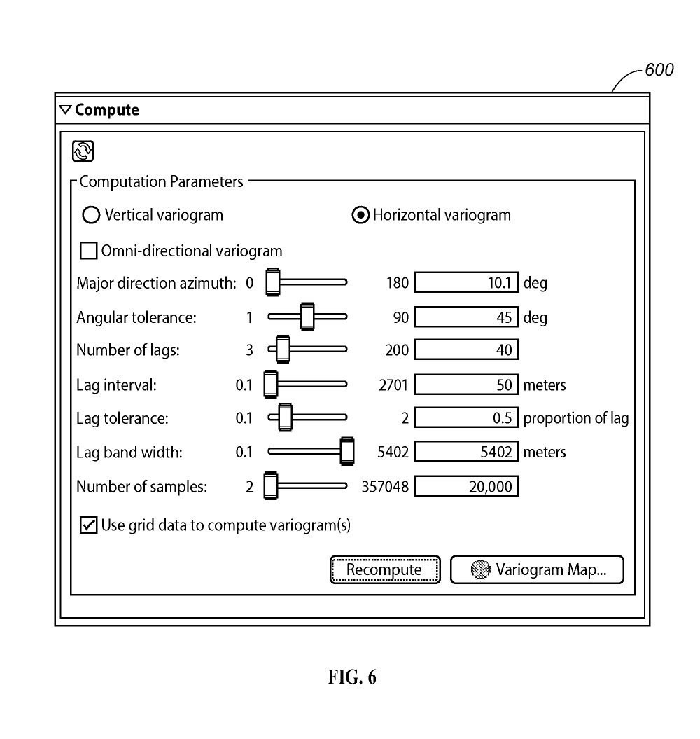

In step 305, an average horizontal cell size of the grid for the grid data selected in step 302 is calculated using techniques well known in the art and is set as the default horizontal unit lag distance for a horizontal experimental variogram. As illustrated by the graphical user interface 600 in FIG. 6, the computed result for the horizontal experimental variogram may be displayed as a lag interval and manually adjusted if necessary.

In step 306, a default number of lags for the vertical experimental variogram and the horizontal experimental variogram are calculated using techniques well known in the art. The default number of lags for a vertical experimental variogram may be calculated, for example, as:

Number of lags=0.5*(thickness of the reservoir)(default vertical unit lag distance). (1)

The computed result for the vertical experimental variogram may be displayed in FIG. 5 as the number of lags, for example, which may be adjusted if necessary. The default number of lags for a horizontal experimental variogram may be calculated, for example, as:

Number of lags=0.5*(horizontal size of the reservoir)(default horizontal unit lag distance). (2)

The computed result for the horizontal experimental variogram may be displayed in FIG. 6 as the number of lags, for example, which may be adjusted if necessary.

In step 308, the secondary data selected in step 302 is randomly sampled using techniques well known in the art to reduce the size of the secondary data to a practical size for use in computing the horizontal experimental variogram. In FIG. 6, for example, the secondary number of samples for the secondary data was reduced to 20,000, which may be adjusted if necessary.

In step 310, the well log data selected in step 302 and the secondary data from step 302 or step 308 are standardized or processed using a normal scored transform-depending on the intended use of the variogram model. If, for example, the variogram model is intended to be used for simulation, then the graphical user interface 400 in FIG. 4 may be used to select a normal score transform to be applied to the well log data and the secondary data using techniques well known in the art. If, however, the variogram model is intended to be used for interpolation (kriging), then the graphical user interface 400 in FIG. 4 may be used to select kriging to standardize the well log data and the secondary data using techniques well known in the art.

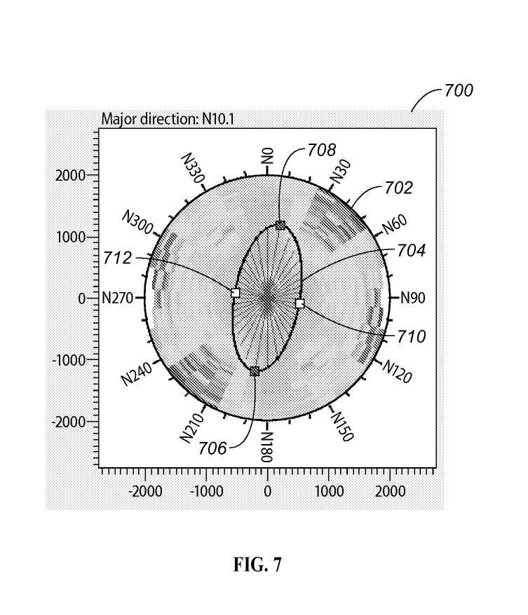

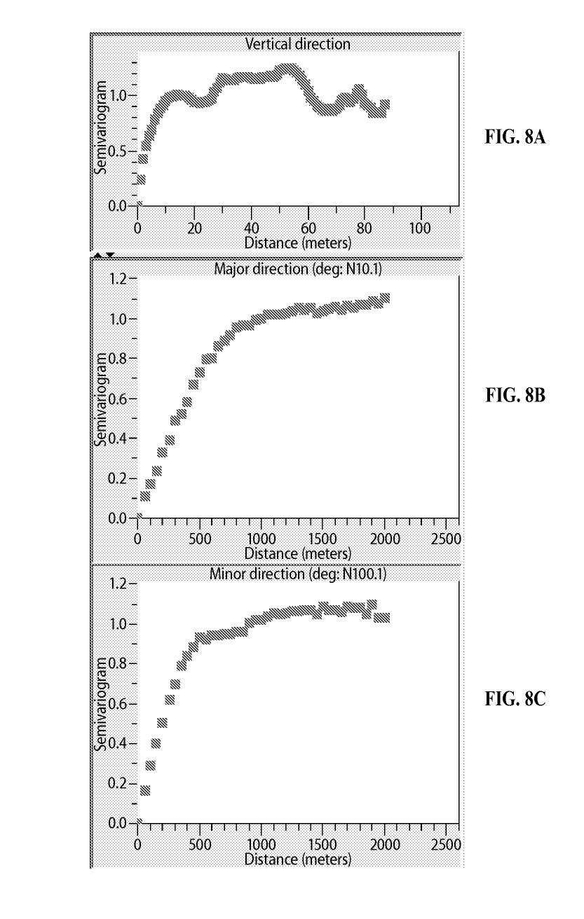

In step 312, the vertical and horizontal experimental variograms are calculated—using techniques well known in the art. The vertical experimental variogram is calculated using the well log data from step 310, the default vertical unit lag distance calculated in step 304 and the default number of lags for the vertical experimental variogram calculated in step 306. The horizontal experimental variograms are calculated along a number of directions using the secondary data from step 310, the default horizontal unit lag distance calculated in step 305 and the default number of lags for the horizontal experimental variogram calculated in step 306. Once the vertical and horizontal experimental variograms are initially calculated, they are processed to auto fit and determine the major direction (major azimuth) for the horizontal experimental variograms using techniques well known in the art. As illustrated by the graphical user interface 700 in FIG. 7, the major direction for the horizontal experimental variograms may be displayed with a variogram map 702 and a rose diagram 704. The major direction lies between points 706 and 708 and is N10.1. The minor direction (minor azimuth) lies between points 710 and 712. Once the direction of the major azimuth is found, as illustrated in FIG. 7, the horizontal experimental variograms are calculated in the major direction and in a direction perpendicular to the major direction. The vertical experimental variogram calculated in the vertical direction according to step 312 is illustrated in FIG. 8A. The horizontal experimental variogram calculated in the major direction and the horizontal experimental variogram calculated in a direction perpendicular to the major direction, according to step 312, are illustrated in FIG. 8B and FIG. 8C, respectively.

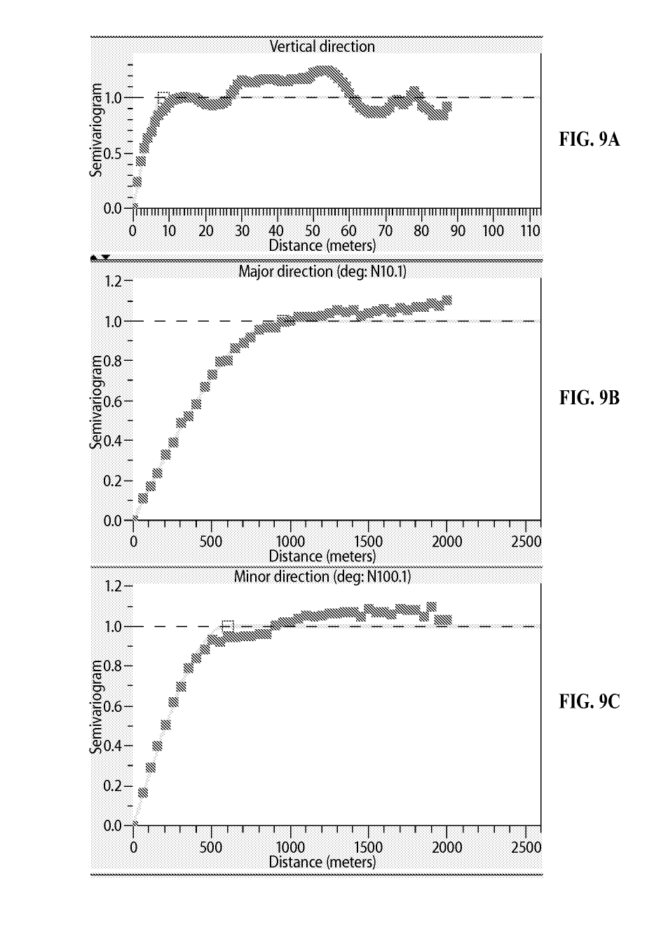

In step 314, the method 300 applies well known auto-fitting techniques to determine the default 3D variogram model as illustrated in FIGS. 9A-C. In FIG. 9A, for example, the graphical representation illustrates the vertical experimental variogram and the autofitted variogram model calculated along the vertical direction in FIG. 8A according to step 314. In FIG. 9B, the graphical representation illustrates the horizontal experimental variogram and the autofitted variogram model calculated along the major direction in FIG. 8B according to step 314. In FIG. 9C, the graphical representation similarly illustrates the horizontal experimental variogram and the autofitted variogram model calculated along the direction perpendicular to the major direction in FIG. 8C according to step 314.

The method 300 therefore, provides an intelligent default variogram model that decreases the cycle time, improves the efficiency of the modeling and is intuitive to less experienced users.

### System Description

The present invention may be implemented through a computer-executable program of instructions, such as program modules, generally referred to as software applications or application programs executed by a computer. The software may include, for example, routines, programs, objects, components, and data structures that perform particular tasks or implement particular abstract data types. The software forms an interface to allow a computer to react according to a source of input. DecisionSpace™, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory-media such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, mini-computers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

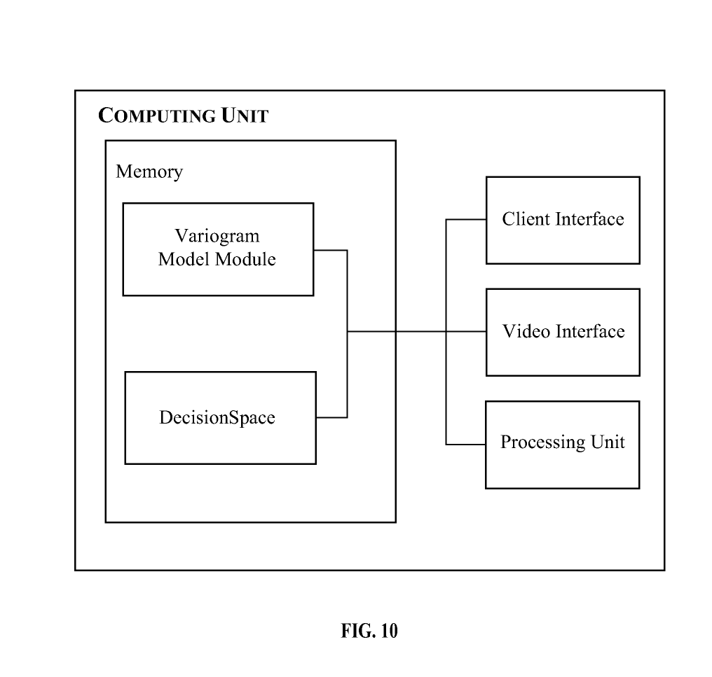

Referring now to FIG. 10, a block diagram illustrates one embodiment of a system for implementing the present invention on a computer. The system includes a computing unit, sometimes referred to as a computing system, which contains memory, application programs, a client interface, a video interface and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIGS. 3-9. The memory therefore, primarily includes a variogram model module, which performs steps 302-314 illustrated in FIG. 3. Although DecisionSpace™ may be used to interface with the variogram model module to provide access to data and a common viewing environment; other interface applications may be used instead of DecisionSpace™ or the variogram model module may be used as a standalone application.

Although the computing unit is shown as having a generalized memory, the computing unit typically includes a variety of computer readable media. By way of example, and not limitation, computer readable media may comprise computer storage media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through application program interface (“API”), which may reside on a separate computing unit connected through a computer system or network. For example only, a hard disk drive may read from or write to nonremovable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above therefore provide storage and/or carry computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through a system bus, but may be connected by other interface and bus structures, such as a parallel port or a universal serial bus (“USB”).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present invention has been described in connection with presently preferred embodiments, it will be understood by those skilled in the art that it is not intended to limit the invention to those embodiments. The present invention, for example, may be used with any type of data that is considered to be a regionalized variable or with any property that has spatial coordinates affiliated with a property measurement. Other industry applications therefore, may include i) environmental studies of trace metals, toxins; ii) mapping the quantity and quality of coal and its potential contaminants such as sulfur and mercury; iii) measuring signal strength in the cellular phone industry; iv) creating maps of aquifers; v) mapping soil patterns; and vi) analyzing and predicting rainfall using Doppler Radar and rainfall measurements. It is therefore, contemplated that various alternative embodiments and modifications may be made to the disclosed embodiments without departing from the spirit and scope of the invention defined by the appended claims and the equivalents thereof.

1. A method for computing a variogram model, which comprises:
selecting input data and grid data, the input data comprising at least well log data and secondary data;
processing the input data using a computer processor to apply a normal score transform to the input data or to standardize the input data;
calculating a vertical experimental variogram using i) the well log data after it is processed using the computer processor; ii) a default vertical unit lag distance; and iii) a default number of lags for the vertical experimental variogram;
calculating horizontal experimental variograms using i) the secondary data after it is processed using the computer; ii) a default horizontal unit lag distance; and iii) a default number of lags for the horizontal experimental variogram; and
auto-fitting the vertical experimental variogram and the horizontal experimental variogram to form the variogram model, which represents a default 3D variogram model.

2. The method of claim 1, wherein the input data is processed using the computer to apply the normal score transform to the input data if the variogram model is intended to be used for simulation.

3. The method of claim 1, wherein the input data is processed using a computer to standardize the input data if the variogram model is intended to be used for interpolation.

4. The method of claim 1, wherein the default vertical unit lag distance is determined by:
calculating a distance between two adjacent samples using the well log data;
collecting each distance between each of the two adjacent samples to form a distribution;
eliminating outliers in the distribution; and
calculating a mean for the distribution, which represents the default vertical unit lag distance.

5. The method of claim 4, wherein the default number of lags for the vertical experimental variogram are calculated using the default vertical unit lag distance.

6. The method of claim 1, wherein the default horizontal unit lag distance is determined by:
calculating an average horizontal cell size of a grid for the grid data; and
setting the average horizontal cell size of the grid as the default horizontal unit lag distance.

7. The method of claim 6, wherein the default number of lags for the horizontal experimental variogram are calculated using the default horizontal unit lag distance.

8. The method of claim 1, further comprising:
sampling the secondary data to reduce its size before processing the input data and calculating the horizontal experimental variogram.

9. The method of claim 1, wherein calculating the vertical experimental variogram and the horizontal experimental variograms comprises processing the vertical experimental variogram and the horizontal experimental variograms to determine the major azimuth direction for the horizontal experimental variograms.

10. The method of claim 9, wherein processing the horizontal experimental variograms comprises calculating the horizontal experimental variograms in the major direction and in a direction perpendicular to the major direction.

11. A non-transitory program carrier device tangibly computer executable instructions for computing a variogram model, the instructions being executable to implement:
selecting input data and grid data, the input data comprising at least well log data and secondary data;
processing the input data using a computer to apply a normal score transform to the input data or to standardize the input data;
calculating a vertical experimental variogram using i) the well log data after it is processed using the computer; ii) a default vertical unit lag distance; and iii) a default number of lags for the vertical experimental variogram;
calculating horizontal experimental variograms using i) the secondary data after it is processed using the computer; ii) a default horizontal unit lag distance; and iii) a default number of lags for the horizontal experimental variogram; and
auto-fitting the vertical experimental variogram and the horizontal experimental variogram to form the variogram model, which represents a default 3D variogram model.

12. The program carrier device of claim 11, wherein the input data is processed using the computer to apply the normal score transform to the input data if the variogram model is intended to be used for simulation.

13. The program carrier device of claim 11, wherein the input data is processed using a computer to standardize the input data if the variogram model is intended to be used for interpolation.

14. The program carrier device of claim 11, wherein the default vertical unit lag distance is determined by:
calculating a distance between two adjacent samples using the well log data;
collecting each distance between each of the two adjacent samples to form a distribution;
eliminating outliers in the distribution; and
calculating a mean for the distribution, which represents the default vertical unit lag distance.

15. The program carrier device of claim 14, wherein the default number of lags for the vertical experimental variogram are calculated using the default vertical unit lag distance.

16. The program carrier device of claim 11, wherein the default horizontal unit lag distance is determined by:
calculating an average horizontal cell size of a grid for the grid data; and
setting the average horizontal cell size of the grid as the default horizontal unit lag distance.

17. The program carrier device of claim 16, wherein the default number of lags for the horizontal experimental variogram are calculated using the default horizontal unit lag distance.

18. The program carrier device of claim 11, further comprising:
sampling the secondary data to reduce its size before processing the input data and calculating the horizontal experimental variogram.

19. The program carrier device of claim 11, wherein calculating the vertical experimental variogram and the horizontal experimental variograms comprises processing the vertical experimental variogram and the horizontal experimental variograms to determine the major azimuth direction for the horizontal experimental variograms.

20. The program carrier device of claim 19, wherein processing the horizontal experimental variograms comprises calculating the horizontal experimental variograms in the major direction and in a direction perpendicular to the major direction.
